(19) United States
(12) Patent Application Publication
(10) Pub. No.: US 2022/0330051 A1
(43) Pub. Date: Oct. 13, 2022

(54) COMMUNICATION METHOD AND APPARATUS

(71) Applicant: HUAWEI TECHNOLOGIES CO., LTD., Shenzhen (CN)

(72) Inventors: Wenjie PENG, Shanghai (CN); Mingzeng DAI, Shenzhen (CN); Rui WANG, Shanghai (CN); Le YAN, Shenzhen (CN)

(21) Appl. No.: 17/850,375

(22) Filed: Jun. 27, 2022

Related U.S. Application Data
(63) Continuation of application No. PCT/CN2019/130552, filed on Dec. 31, 2019.

(51) Int. Cl. H04W 24/02; H04W 24/10; H04W 48/08; H04W 64/00; H04B 7/185

(52) U.S. Cl. CPC H04W 24/02; H04W 24/10; H04W 48/08; H04W 64/006; H04B 7/18504

(57) ABSTRACT

A communication method and an apparatus. A terminal device determines height information, where a first parameter is related to the height information. The terminal device receives configuration information from a first network device, where the configuration information includes a correspondence between the height information and the first parameter. The terminal device determines, based on the height information, the first parameter corresponding to the terminal device. The first parameter includes one or more of a tracking area parameter, a radio access network notification area parameter, a cell selection or reselection parameter, and a measurement configuration parameter. Configuration information corresponding to a height of an uncrewed aerial vehicle is provided, to ensure that an uncrewed aerial vehicle terminal device at a high height obtains an effective configuration parameter, so that user experiences at different heights is improved.

### CROSS-REFERENCE TO RELATED APPLICATIONS

This application is a continuation of International Application No. PCT/CN2019/130552, filed on Dec. 31, 2019. The disclosures of the aforementioned application is hereby incorporated by reference in its entirety.

### BACKGROUND

In a wireless communication network, a clear cell topology structure is determined on a ground through network planning, an automatic neighbor relation (automatic neighbor relation, ANR), minimization of drive tests (minimization of drive tests, MDT), and the like. The neighbor relation is mostly maintained based on perception of a terrestrial user terminal.

Application of an uncrewed aerial vehicle (unmanned aerial vehicle, UAV) is increasingly popular in today's society. Communication environment of the uncrewed aerial vehicle is different from that of a common terminal to some extent. The uncrewed aerial vehicle moves above the ground, and different types of uncrewed aerial vehicles have different flight heights. Under same network deployment, how to ensure that a UAV at a high height obtains effective configuration information becomes an urgent problem to be resolved.

### SUMMARY

At least one embodiment provides a communication method and an apparatus, to resolve a problem that configuration information obtained by a terminal device (for example, an uncrewed aerial vehicle terminal device) at a high height is not adaptive.

According to a first aspect, at least one embodiment provides a communication method, where the method is performed by a terminal device, or is performed by a component (for example, a processor, a chip, or a chip system) of the terminal device, and includes: receiving configuration information from a first network device, where the configuration information includes a correspondence between height information and a first parameter; and determining a target parameter based on a current height of the terminal device, where the first parameter includes one or more of a tracking area parameter, a radio access network notification area parameter, a cell selection or reselection parameter, and a measurement configuration parameter.

Optionally, the determining a target parameter based on a current height of the terminal device includes: determining the target parameter based on the height information and the configuration information.

According to the foregoing method, the terminal device determines the target parameter based on the height information. In other words, the terminal device obtains, based on the height information, the target parameter corresponding to the height information, so that user experience is improved. For example, the terminal device at different heights performs cell selection or reselection by using different cell selection or reselection parameters, and this improves cell reselection reliability.

In at least one embodiment, the correspondence is a table. Optionally, the correspondence between the height information of the terminal device and the first parameter is a function. In other words, the first network device configures, for the terminal device by sending the correspondence, one or more first parameters corresponding to the height information.

According to the foregoing implementations, the terminal device obtains the correspondence between the height information of the terminal device and the first parameter in a plurality of possible implementations.

In at least one embodiment, a height threshold is received by using the configuration information, so that the height information is determined based on the current height of the terminal device and the height threshold.

Optionally, the height information is a height range, or the height information is a height level, or the height information is an absolute height or a relative height.

In at least one embodiment, the terminal device determines the height information based on the current height, or determine the height information based on the current height and the height threshold.

In at least one embodiment, measurement information is alternatively sent to the first network device, where the measurement information includes identification information of a cell and a height corresponding to the cell, so that the first network device updates the neighbor relation based on the reported measurement information that carries the height information.

In at least one embodiment, the measurement information sent by the terminal device is information obtained through event measurement, or is information obtained through periodic measurement.

Optionally, the terminal device obtains the measurement information at an interval of a specific height.

In at least one embodiment, the terminal device sends, to the first network device, the measurement information that carries the height information, and this helps the first network device complete the neighbor relation.

According to a second aspect, at least one embodiment provides a communication method, where the method is performed by a first network device, or is performed by a component (for example, a processor, a chip, or a chip system) of the first network device, and includes: determining a correspondence between a first parameter and height information; and sending configuration information to a terminal device, where the configuration information includes the correspondence between the first parameter and the height information, and the first parameter includes one or more of a tracking area parameter, a radio access network notification area parameter, a cell selection or reselection parameter, and a measurement configuration parameter.

In at least one embodiment, the first network device configures at least one set of first parameters that have a correspondence with height information for the terminal device, so that user experience at different heights is improved.

In at least one embodiment, the height information includes one of a height range, a height level, an absolute height, and a relative height. In at least one embodiment, the configuration information includes a height threshold, where the height threshold is related to the height information.

Optionally, the terminal device determines the height information based on the height threshold and a current height of the terminal device.

In at least one embodiment, the first network device sends the height threshold to the terminal device, so that the terminal device determines the height information, and this helps the terminal device obtain a target parameter corresponding to the height information.

In at least one embodiment, the method in the second aspect alternatively includes: receiving measurement information from the terminal device, where the measurement information includes identification information of a cell and a height corresponding to the cell.

In at least one embodiment, the first network device updates a neighbor relation based on the identification information of the cell and the height corresponding to the cell that are carried in the measurement information.

According to a third aspect, at least one embodiment provides a communication method. The method is performed by a first network device, or is performed by a component (for example, a processor, a chip, or a chip system) of the first network device, and includes: receiving first information from a second network device, where the first information includes neighboring cell information of the second network device and height information corresponding to the neighboring cell information. The first network device maintains the neighboring cell information based on the first information, where the neighboring cell information includes a neighboring cell identifier or a neighboring cell list.

In at least one embodiment, the first network device stores the first information. Optionally, the first network device updates or maintains the neighboring cell information based on the first information.

Optionally, the neighboring cell information of the second network device further includes one or more of a tracking area parameter or a radio access network notification area parameter.

In at least one embodiment, the first network device updates a neighbor relation, tracking area information, and radio access network notification area information based on height information that is of a neighboring cell and that is exchanged by the second network device.

In at least one embodiment, the method in the third aspect alternatively includes a step of sending second information to the second network device, where the second information includes neighboring cell information of the first network device and height information corresponding to the neighboring cell information.

Optionally, the neighboring cell information of the first network device further includes one or more of a tracking area parameter or a radio access network notification area parameter.

In at least one embodiment, the second network device updates a neighbor relation based on height information that is of a neighboring cell and that is exchanged by the first network device, complete a neighboring cell topology relation, and update the tracking area information and the radio access network notification area information.

According to a fourth aspect, at least one embodiment provides a communication method. The method is performed by a second network device, or is performed by a component (for example, a processor, a chip, or a chip system) of the second network device, and includes: The second network device maintains neighboring cell information based on height information, where the neighboring cell information includes a neighboring cell identifier or a neighboring cell list; and sends first information to a first network device, where the first information includes the neighboring cell information of the second network device and height information corresponding to the neighboring cell information.

In at least one embodiment, the second network device sends, to the first network device, the neighboring cell information corresponding to the height information, and the first network device updates a neighbor relation based on height information that is of a neighboring cell and that is exchanged by the second network device.

In at least one embodiment, the method in the fourth aspect alternatively includes a step of receiving second information from the first network device, where the second information includes neighboring cell information of the first network device and height information corresponding to the neighboring cell information.

According to a fifth aspect, at least one embodiment provides a communication apparatus, to implement the method in any one of the first aspect or the possible implementations of the first aspect. The apparatus includes a corresponding unit or component configured to perform the foregoing method. The unit included in the apparatus is implemented by using software and/or hardware. The apparatus is, for example, a terminal device, or a chip, a chip system, or a processor that supports the terminal device in implementing the foregoing method.

According to a sixth aspect, at least one an embodiment provides a communication apparatus, to implement the method in any one of the second aspect or the possible implementations of the second aspect, or any one of the third aspect or the possible implementations of the third aspect. The apparatus includes a corresponding unit or component configured to perform the foregoing method. The unit included in the apparatus is implemented by using software and/or hardware. The apparatus is, for example, a first network device, or a chip, a chip system, or a processor that supports the first network device in implementing the foregoing method.

According to a seventh aspect, at least one embodiment provides a communication apparatus, to implement the method in any one of the fourth aspect or the possible implementations of the fourth aspect. The apparatus includes a corresponding unit or component configured to perform the foregoing method. The unit included in the apparatus is implemented by using software and/or hardware. The apparatus is, for example, a second network device, or a chip, a chip system, or a processor that supports the second network device in implementing the foregoing method.

According to an eighth aspect, at least one embodiment provides a communication apparatus, including a processor, where the processor is coupled to a memory, the memory is configured to store a program or instructions, and in response to the program or the instructions being executed by the processor, the apparatus is enabled to implement the method in any one of the first aspect or the possible implementations of the first aspect.

According to a ninth aspect, at least one embodiment provides a communication apparatus, including a processor, where the processor is coupled to a memory, the memory is configured to store a program or instructions, and in response to the program or the instructions being executed by the processor, the apparatus is enabled to implement the method in any one of the second aspect or the possible implementations of the second aspect, or the method in any one of the third aspect or the possible implementations of the third aspect.

According to a tenth aspect, at least one embodiment provides a communication apparatus, including a processor, where the processor is coupled to a memory, the memory is configured to store a program or instructions, and in response to the program or the instructions being executed by the processor, the apparatus is enabled to implement the method in any one of the fourth aspect or the possible implementations of the fourth aspect.

According to an eleventh aspect, at least one embodiment provides a computer-readable storage medium, where the computer-readable storage medium stores a computer program or instructions, and in response to the computer program or the instructions being executed, a computer is enabled to perform the method in any one of the first aspect, the second aspect, the third aspect, the fourth aspect, or the possible implementations of the first aspect, the second aspect, the third aspect, or the fourth aspect.

According to a twelfth aspect, at least one embodiment provides a computer program product, where the computer program product includes computer program code, and in response to the computer program code being run on a computer, the computer is enabled to perform the method in any one of the first aspect, the second aspect, the third aspect, the fourth aspect, or the possible implementations of the first aspect, the second aspect, the third aspect, or the fourth aspect.

According to a thirteenth aspect, at least one embodiment provides a chip, including a processor, where the processor is coupled to a memory, the memory is configured to store a program or instructions, and in response to the program or the instructions being executed by the processor, the chip is enabled to implement the method in any one of the first aspect, the second aspect, the third aspect, the fourth aspect, or the possible implementations of the first aspect, the second aspect, the third aspect, or the fourth aspect.

According to a fourteenth aspect, at least one embodiment provides a communication system, including the apparatus according to the fifth aspect, the apparatus according to the sixth aspect, and the apparatus according to the seventh aspect.

### BRIEF DESCRIPTION OF DRAWINGS

FIG. 1 is a schematic diagram of a communication system according to at least one embodiment;

FIG. 1A is a schematic diagram of coverage of cells at different heights according to at least one embodiment;

FIG. 2 is a schematic diagram of an example of an architecture of a communication system according to at least one embodiment;

FIG. 3 is a schematic interaction diagram of a communication method according to at least one embodiment;

FIG. 4 is a schematic interaction diagram of a communication method according to at least one embodiment;

FIG. 5 is a schematic diagram of a structure of a communication apparatus according to at least one embodiment; and

FIG. 6 is a schematic diagram of another communication apparatus according to at least one embodiment.

### DESCRIPTION OF EMBODIMENTS

First, a communication system to which the technical solutions provided in at least one embodiment are applicable is described.

The technical solutions in at least one embodiment is applied to various communication systems, for example, a long term evolution (long term evolution, LTE) system, a 5th generation (5th generation, 5G) communication system, a wireless-fidelity (wireless-fidelity, Wi-Fi) system, a new radio (new radio, NR) system, a system integrating a plurality of communication systems, or a future evolved communication system, and another network system that is used to provide a communication service. This is not limited herein.

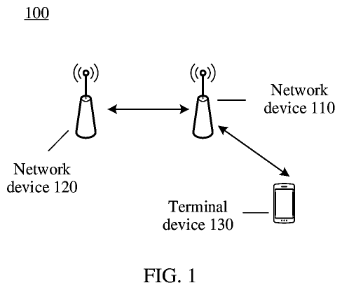

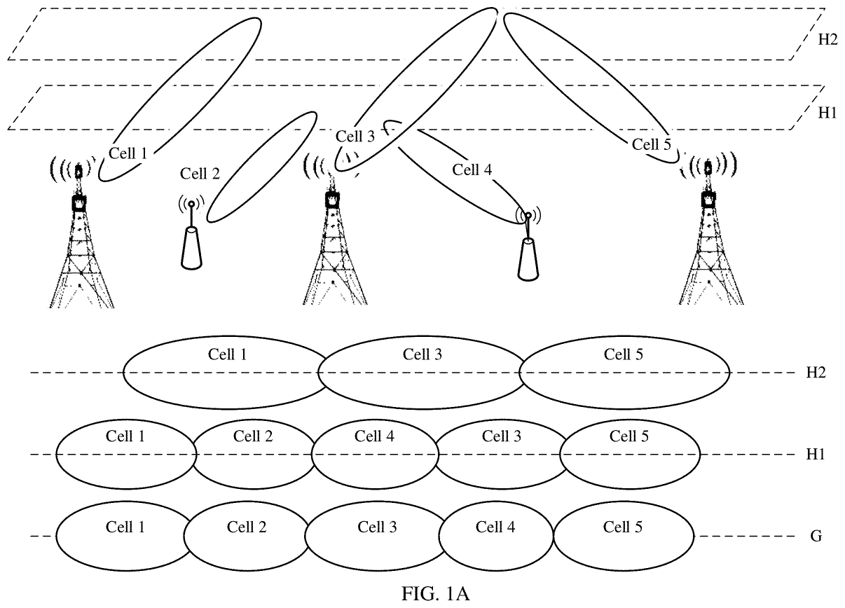

FIG. 1 is an example of a schematic diagram of a communication system according to at least one embodiment. The communication system 100 includes one or more network devices (where a network device 110 and a network device 120 are shown in the figure), and one or more terminal devices that communicate with the one or more network devices. As shown in FIG. 1, the network device 110 communicates with the network device 120, and a terminal device 130 communicates with the network device 110. A network device and a terminal device is also referred to as communication devices.

FIG. 2 is a schematic diagram of an example of an architecture of a communication system according to at least one embodiment. As shown in FIG. 2, a network device in a radio access network (radio access network, RAN) is a base station (for example, a gNodeB or a gNB) in an architecture in which a centralized unit (centralized unit, CU) and a distributed unit (distributed unit, DU) are separated. The RAN is connected to a core network (for example, is an LTE core network or a 5G core network). The base station is divided into the CU and the DU from the perspective of a logical function. The CU and the DU is physically separated or deployed together. A plurality of DUs shares one CU. One DU is alternatively connected to a plurality of CUs (not shown in the figure). The CU and the DU is connected through an interface, for example, is an F1 interface.

Optionally, the CU and the DU is obtained through division based on protocol layers of a wireless network. For example, functions of a radio resource control (Radio Resource Control, RRC) layer, a service data adaptation protocol (Service Data Adaptation Protocol, SDAP) layer, and a packet data convergence protocol (packet data convergence protocol, PDCP) layer are deployed on the CU, and functions of a radio link control (radio link control, RLC) layer, a media access control (Media Access Control, MAC) layer, a physical (physical, PHY) layer, and the like are deployed on the DU. Division of processing functions of the CU and the DU based on the protocol layers is merely an example, and the division of the processing functions of the CU and the DU is alternatively in another manner.

Optionally, the CU or the DU alternatively has some processing functions of the protocol layers through division. In a possible design, some functions of the RLC layer and functions of a protocol layer above the RLC layer are deployed on the CU, and remaining functions of the RLC layer and functions of a protocol layer below the RLC layer are deployed on the DU. In another possible design, division of functions of the CU or the DU is performed based on a service type or another system characteristic. For example, division is performed based on a latency. Functions whose processing time meets a latency requirement are deployed on the DU, and functions whose processing time does not meet the latency requirement are deployed on the CU. A network architecture shown in FIG. 2 is applied to a 5G communication system, and alternatively shares one or more components or resources with an LTE system. In another design, the CU alternatively has one or more functions of a core network. One or more CUs is disposed in a centralized manner or a separated manner. For example, the CUs is disposed on a network side for ease of centralized management. The DU has a plurality of radio frequency functions, or the radio frequency functions is disposed remotely.

Optionally, functions of the CU is implemented by one entity, or is implemented by different entities. For example, the functions of the CU is further divided. For example, a control plane (Control Plane, CP) is separated from a user plane (User Plane, UP), that is, a CU control plane (CU-CP) is separated from a CU user plane (CU-UP). For example, the CU-CP and the CU-UP is implemented by different functional entities. The CU-CP and the CU-UP is coupled to the DU to jointly implement functions of the base station. In a possible manner, the CU-CP is responsible for control plane functions, and mainly includes an RRC and a PDCP-C. The PDCP-C is mainly responsible for data encryption and decryption, integrity protection, serial number maintenance, data transmission, and the like on the control plane. The CU-UP is responsible for user plane functions, and mainly includes an SDAP and a PDCP-U. The SDAP is mainly responsible for processing data of the core network and mapping a data flow (flow) to a bearer. The PDCP-U is mainly responsible for encryption and decryption, integrity protection, header compression, serial number maintenance, data transmission, and the like on a data plane. The CU-CP and the CU-UP are connected through an E1 interface.

At least one embodiment is also applicable to an architecture in which the CU and the DU are not separated.

In at least one embodiment, the network device is any device having a wireless transceiver function. The network device includes but is not limited to: an evolved NodeB (NodeB or eNB or e-NodeB, evolutional NodeB) in LTE, a base station (gNodeB or gNB) or a transmission reception point (transmission receiving point/transmission reception point, TRP) in NR, a base station that subsequently evolves in 3GPP, an access node in a Wi-Fi system, a wireless relay node, a wireless backhaul node, or the like. The base station is a macro base station, a micro base station, a picocell base station, a small cell, a relay station, a balloon station, or the like. A plurality of base stations supports the aforementioned networks of a same technology, or supports the aforementioned networks of different technologies. The base station includes one or more co-site or non-co-site TRPs. The network device is alternatively a radio controller, a CU, and/or a DU in a cloud radio access network (cloud radio access network, CRAN) scenario. The network device is alternatively a server, a wearable device, a vehicle-mounted device, or the like. An example in which the network device is a base station is used for description below. The plurality of network devices is base stations of a same type or base stations of different types. The base station communicates with a terminal device, or communicates with the terminal device through a relay station. The terminal device communicates with a plurality of base stations using different technologies. For example, the terminal device communicates with a base station supporting an LTE network, communicates with a base station supporting a 5G network, and further supports dual connectivity to a base station in an LTE network and a base station in a 5G network. The network device in at least one embodiment is also referred to as an access network device.

The terminal device is user equipment (user equipment, UE), an access terminal, a subscriber unit, a subscriber station, a mobile station, a mobile console, a remote station, a remote terminal, a mobile device, a user terminal, a terminal, a wireless terminal device, a user agent, or a user apparatus. The terminal is alternatively a cellular phone, a cordless phone, a wireless local loop (wireless local loop, WLL) station, a personal digital assistant (personal digital assistant, PDA) device, a handheld device having a wireless communication function, a computing device, another processing device connected to a wireless modem, a mobile phone (mobile phone), a tablet computer (Pad), a computer having a wireless transceiver function, a virtual reality (virtual reality, VR) terminal device, an augmented reality (augmented reality, AR) terminal device, a wireless terminal in industrial control (industrial control), a vehicle-mounted terminal device, a wireless terminal in self driving (self driving), a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), a wearable terminal device, a terminal device in a future 5G network, a terminal device in a future evolved PLMN, or the like. Alternatively, the terminal is fixed or mobile, and the terminal is deployed on land, in water, or in the air.

In addition, in at least one embodiment, the terminal device is alternatively an uncrewed aerial vehicle (unmanned aerial vehicle, UAV). The uncrewed aerial vehicle in at least one embodiment is alternatively a uncrewed aerial vehicle, or is an uncrewed aerial vehicle carrying a ground terminal device (for example, the terminal device is placed on an uncrewed aerial vehicle). The ground terminal device is also referred to as a common terminal device, a mobile ground terminal device, or the like. A location of the ground terminal device is close to a ground.

In the method provided in at least one embodiment, that the network device configures, for the terminal device (for example, a UAV), a configuration parameter that has a correspondence with a height is understood as that the network device sets different configuration parameters for the terminal device by using a height as a granularity. In other words, the network device configures different configuration parameters for the terminal device at different heights. The terminal device selects, based on a correspondence between a height and a configuration parameter, a configuration parameter corresponding to the height of the terminal device, to improve user experience at different heights.

The height at which the terminal device is located is a height relative to a ground, a height relative to a sea level, or a height relative to a reference point. In a possible embodiment, a height relative to a ground or a sea level is referred to as an absolute height, and a height relative to a reference point is referred to as a relative height.

The following describes at least one embodiment with reference to the accompanying drawings. In at least one embodiment, implementations are combined with each other, and same or similar concepts or processes are not described repeatedly in some embodiments. A function explained in at least one embodiment is implemented by using an independent hardware circuit, software running in combination with a processor/microprocessor or a general-purpose computer, an application-specific integrated circuit, and/or one or more digital signal processors. When described as a method, at least one embodiment is alternatively implemented in a computer processor and a memory coupled to the processor.

Cell topologies of the terminal device at different heights are different, to be specific, neighboring cells corresponding to a cell at different heights are different. In addition, cell coverage of the cell at different heights is also different. As shown in FIG. 1A, G in the figure represents a ground, H1 and H2 are height information and used to identify high heights, and H2>H1. Cell 3 in FIG. 1A is used as an example. Neighboring cells of cell 3 on the ground are cell 2 and cell 4. Neighboring cells of cell 3 at a height of H1 are cell 4 and cell 5. Neighboring cells of cell 3 at a height of H2 are cell 1 and cell 5. That is, cell 3 corresponds to different neighboring cells at different heights. On the other hand, although cell 3 is adjacent to cell 5 at both H1 and H2, coverage of cell 3 at the height of H1 is different from that of cell 5 at the height of H2, that is, coverage of a same cell is different at different heights.

For ease of understanding at least one embodiment, some concepts or terms used are first briefly described.

1. Cell reselection: After a terminal device camps on a cell, as the terminal device moves, the terminal device hands over to another suitable cell for camping. The another suitable cell is, for example, another cell with a higher priority or a better signal. This is a cell reselection process.

For example, parameters related to cell reselection include:

a. cellSelectionInfo in a system information block type 1 (system information block type 1, SIB1), that is, a parameter related to cell selection of a current serving cell, including at least one of the following: q-RxLevMin, q-RxLevMinOffset, q-RxLevMiSUL, q-QualMin, and q-QualMinOffset.

b. cellReselectionInfoCommon, cellReselectionServingFreqInfo, and intraFreqCellReselectionInfo in a system information block type 2 (system information block type 2, SIB2).

cellReselectionInfoCommon is common information of intra-frequency/inter-frequency/inter-RAT cell reselection, and includes, for example, one or more of the following parameters: q-Hyst and speedStateReselectionPars.

cellReselectionServingFreqInfo is common information of a non-intra-frequency cell, that is, common information used for inter-frequency/inter-RAT cell reselection, and includes, for example, at least one of the following parameters: a cell reselection priority, a cell reselection sub-priority, s-NonIntraSearchP, s-NonIntraSearchQ, threshServingLowP, and threshServingLowQ.

intraFreqCellReselectionInfo is information about intra-frequency cell reselection, and includes, for example, at least one of the following parameters: q-RxLevMin, q-RxLevMiSUL, q-QualMin, s-IntraSearchP, s-IntraSearchQ, and t-ReselectionNR.

c. intraFreqNeighCellList and intraFreqBlackCellList in a system information block type 3 (system information block type 3, SIB3).

intraFreqNeighCellList is an intra-frequency neighboring cell information list, and the list includes at least one piece of intra-frequency neighboring cell information, where the intra-frequency neighboring cell information includes a cell identifier and a parameter related to the cell reselection. intraFreqBlackCellList is a blacklist of intra-frequency neighboring cells.

d. interFreqCarrierFreqList in a system information block type 4 (system information block type 4, SIB4).

interFreqCarrierFreqList is information about inter-frequency cell reselection, and a specific parameter includes inter-frequency frequency information, corresponding frequency band information, and corresponding parameters related to the cell reselection.

Optionally, for descriptions of the foregoing parameters, further refer to the 3GPP standard protocol TS 38.304 v15.4.0. However, this is not limited in at least one embodiment.

2. Tracking area code (tracking area code, TAC): a serial number of a tracking area. The TAC is used to identify the tracking area. The TAC is not globally unique but uniquely identifies a same operator.

3. Tracking area identity (tracking area identity, TAI): including a public land mobile network identity (public land mobile network identity, PLMN ID) and the TAC. The TAI is used to identify the tracking area. The TAI is a globally unique identifier.

4. Radio access network notification area code (radio access network based notification area code, RNAC): a serial number of a radio access network notification area. A radio access network notification area identifier includes the PLMN ID, the TAC, and the RNAC. The radio access network notification area identifier is used to identify the radio access network notification area, and the radio access network notification area identifier is a globally unique identifier.

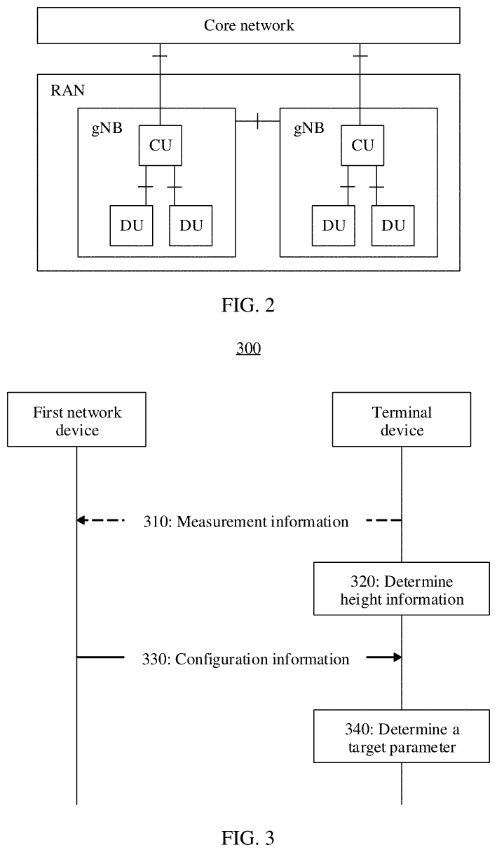

FIG. 3 is a schematic interaction diagram of a communication method 300 according to an at least one embodiment. FIG. 3 shows the communication method by using an example in which a first network device and a terminal device are execution bodies of an interaction example. However, the execution bodies of the interaction example are not limited in at least one embodiment.

It is understood that steps or procedures implemented by the first network device in FIG. 3 is alternatively implemented by a chip, a chip system, a processor, or the like that supports the first network device in implementing the method. In FIG. 3, the steps or procedures implemented by the terminal device is alternatively implemented by a chip, a chip system, a processor, or the like that supports the terminal device in implementing the method.

As shown in FIG. 3, the method 300 includes the following operations.

Operation 320: The terminal device determines height information.

In at least one embodiment, the height information is a height range. In other words, the terminal device determines, based on a current height, a height range in which the terminal device is located.

In at least one embodiment, the height information is a height level. In other words, the terminal device determines the height level based on a current height and a height threshold. the height threshold is predefined, or received from the network device. The height information is also referred to as a height factor, a height parameter, or the like. This is not limited in this embodiment of at least one embodiment.

In at least one embodiment, the height information is a height of the terminal device relative to the first network device.

Operation 330: The first network device sends configuration information to the terminal device, where the configuration information includes at least one piece of height information and a first parameter corresponding to the at least one piece of height information.

Correspondingly, the terminal device receives the configuration information from the first network device.

A sequence of determining the height information by the terminal device and receiving, by the terminal device, the configuration information from the first network device is not limited in at least one embodiment. In other words, operations 320 and 330 is simultaneously performed, or operation 320 is performed after operation 330.

The first parameter includes one or more of a tracking area parameter, a radio access network notification area parameter, a cell selection or reselection parameter, and a measurement configuration parameter.

In at least one embodiment, a first parameter in the configuration information received from the first network device includes one of the tracking area parameter, the radio access network notification area parameter, the cell selection or reselection parameter, and the measurement configuration parameter, or is a combination of a plurality of parameters. These parameters are sent in one piece of configuration information, or are respectively sent in a plurality of pieces of configuration information.

The tracking area parameter is a tracking area identifier (TAI) or TAC, the radio access network notification area parameter is a radio access network notification area identifier or RNAC, and the measurement configuration parameter is a configuration parameter of the terminal is used to perform measurement (for example, minimization of drive tests (minimization of drive tests, MDT)).

In at least one embodiment, the first network device configures corresponding first parameters for different height information, and send the first parameters to the terminal device. The first parameter corresponding to the height information is also referred to as the first parameter related to the height information, that is, there is a correspondence between height information and a first parameter.

The first network device sends the configuration information to the terminal device in a plurality of different manners. In at least one embodiment, the first parameter that has a correspondence with the height information is understood as that the terminal device at different heights selects first parameters corresponding to the heights of the terminal device.

The correspondence between the first parameter and the height information is implemented in a plurality of different manners. For example, the correspondence is implemented in a form of a table, or is implemented in a form of a function, or is implemented by using another data structure, for example, is implemented by using an array, a queue, a container, a stack, a linear table, a pointer, a linked list, a tree, a graph, a structure, a class, a heap, a hash table, or the like.

In at least one embodiment, the correspondence between the first parameter and the height information of the terminal device is implemented in a form of a table. For example, the correspondence between the first parameter and the height information is shown in Table 1.

TABLE 1

| First parameter list | Height |
|---|---|
| Parameter 1 | Less than or equal to T_{hight1} |
| Parameter 2 | Greater than T_{hight1} |

In Table 1, T_{hight1} is a height threshold, and parameter 1 and parameter 2 are different first parameters. T_{hight1} is predefined, or is configured by the first network device for the terminal device. For example, T_{hight1} is pre-stored in a corresponding apparatus (for example, a memory, a cache, a storage medium, or another apparatus that is used to store data), and the terminal device reads T_{hight1} from the apparatus to obtain T_{hight1}. “Predefine” in at least one embodiment is understood as “define”, “predefine”, “store”, “pre-store”, “pre-negotiate”, “pre-configure”, “solidify”, or “pre-burn”. Parameter 1 and parameter 2 is configured by the first network device for the terminal device.

Operation 340: The terminal device determines a target parameter. As shown in Table 1, the terminal device selects (or determines) a target parameter in operation 340 corresponding to a height of the terminal device from a plurality of sets of first parameters that are in a correspondence with height information. For example, in response to the height of the terminal device being less than or equal to the height threshold T_{hight1}, a target parameter selected by the terminal device is parameter 1; or in response to the height of the terminal device being greater than T_{hight1}, a target parameter selected by the terminal device is parameter 2. A specific value of the height threshold is not limited in at least one embodiment. For example, the height threshold is 50 m.

In at least one embodiment, the height information is fixed, and the height information is determined by the first network device, or is determined by a network management system. In at least one embodiment, the configuration information in operation 330 does not carry the height information, a plurality of sets of parameters in the configuration information correspond to the height information in an order, and the plurality of sets of parameters is arranged in descending order of the height information, or is arranged in ascending order of the height information. The terminal device selects, from the configuration information, a target parameter corresponding to an order of the height information of the terminal device.

In another possible implementation, a plurality of height thresholds is configured. To be specific, N thresholds are introduced, where N is greater than or equal to 2. Correspondingly, space is divided into N+1 parts in terms of height, and there is N+1 sets of corresponding first parameters. Parameter 1 to parameter N+1 is configured by the first network device for the terminal device.

For example, the correspondence between N+1 sets of first parameters and height information is shown in Table 3.

TABLE 3

| First parameter | Corresponding Height |
|---|---|
| Parameter 1 | Less than T_{hight1} |
| Parameter 2 | Greater than T_{hight1}, less than or equal to T_{hight2} |
| . . . | . . . |
| Parameter N | Greater than T_{hightN-1}, less than or equal to T_{hightN} |
| Parameter N + 1 | Greater than T_{hightN} |

As shown in Table 3, in response to the height of the terminal device being greater than T_{hight1} and less than or equal to T_{hight2}, a target parameter selected by the terminal device from received N+1 sets of parameters is parameter 2; in response to the height of the terminal device being greater than T_{hightN-1} and less than or equal to T_{hightN}, a target parameter selected by the terminal device from received N+1 sets of parameters is parameter N; or in response to the height of the terminal device is greater than T_{hightN}, a target parameter selected by the terminal device from received N+1 sets of parameters is parameter N+1. Height thresholds T_{hight1}, T_{hight2}, T_{hight3}, . . . , T_{hightN} is predefined, or is configured by the first network device for the terminal device, where T_{hight1}<T_{hight2}<T_{hight3}< . . . <T_{hightN}. Differences between adjacent height thresholds is the same or is different.

Items in the height threshold column in Table 3 is alternatively sorted in descending order. In other words, the height thresholds are alternatively sorted in descending order. This is not limited in at least one embodiment.

For example, introducing two height thresholds is used as an example. T_{hight1}=50 and T_{hight2}=150 is introduced. A unit of the height threshold is meter (m), kilometer, or the like. In at least one embodiment, an example in which the unit of the height threshold is meter is used. The correspondence between the first parameter and the height information is shown in Table 4.

TABLE 4

| First parameter | Height |
|---|---|
| Parameter 1 | Less than 50 m |
| Parameter 2 | Greater than 50 m and less than or equal to 150 m |
| Parameter 3 | Greater than 150 m |

As shown in Table 4, two thresholds are introduced in Table 4. Correspondingly, space is divided into three parts in terms of height, and there is three sets of corresponding first parameters. To be specific, in response to the height of the terminal device being less than or equal to 50 m, a target parameter selected by the terminal device is parameter 1, and the parameter 1 is understood as a parameter corresponding to a low-height or ground terminal device; in response to the height of the terminal device being greater than 50 m and less than or equal to 150 m, a target parameter selected by the terminal device is parameter 2; or in response to the height of the terminal device being greater than 150 m, a target parameter selected by the terminal device is parameter 3.

In at least one embodiment, the terminal device determines the height information (height level). In other words, the height information is a form of the height level, and the terminal device determines, based on a correspondence between a height level and a first parameter, the first parameter corresponding to the current height of the terminal device. A plurality of height levels is configured. For example, N levels are introduced, where N is greater than or equal to 2. Correspondingly, space is divided into N parts in terms of height, and there is N sets of corresponding first parameters. Parameter 1 to parameter N is configured by the first network device for the terminal device.

For example, a correspondence between N sets of first parameters and height information is shown in Table 5.

TABLE 5

| Height Level | First parameter |
|---|---|
| First level | Parameter 1 |
| Second level | Parameter 2 |
| . . . | . . . |
| N^{th} level | Parameter N |

There is a plurality of implementations for division of height levels. Optionally, the division of height levels is predefined. Optionally, the height level is determined by a first network device. In other words, the first network device configures the height level for the terminal device, or the first network device indicates a rule of the height level to the terminal device. The height level is similar to the height threshold described above that, the first network device indicates the height level by sending the height threshold to the terminal device. For example, the height threshold T_{hight1} is sent. A current height of the terminal device less than T_{hight1} is a first level; and a current height of the terminal device greater than T_{hight1} is a second level. Optionally, the first network device sends a plurality of height thresholds. In other words, the terminal device has a plurality of height levels, and different height levels correspond to different first parameters.

It is easy to understand that the height level is also referred to as a height factor, a height rule, or a height measurement. This is not limited in at least one embodiment.

In another possible implementation, the correspondence between the first parameter and the height information of the terminal device is implemented in a form of a function. For example, the first parameter is obtained by using a function ƒ(h), where his an absolute height of the terminal device, or is a relative height difference between the terminal device and the first network device. For example, at least one embodiment of the function ƒ(h) is:

$$f ( h ) = \{ \begin{matrix}Parameter 1 , & h \leq {T}_{hight 1} \\ Parameter 2 , & {T}_{hight 1} < h \leq {T}_{hight 2} \\ … & \\ Parameter N + 1 , & {T}_{hightN} < h\end{matrix}$$

T_{hight1}, T_{hight2}, . . . , and T_{hightN} are height thresholds. The height thresholds is predefined, or is configured by the first network device for the terminal device.

Another function or another implementation of the function that implements the correspondence between the first parameter and the height information is not limited in at least one embodiment.

Optionally, the configuration information is carried in a broadcast message. The configuration information is alternatively carried in another message, for example, an RRC reconfiguration message.

The terminal device determines, based on the height information, a target parameter used at the current height, in other words the terminal device determines the target parameter based on the height information and the correspondence between the height information and the first parameter. In at least one embodiment, the terminal device determines the target parameter is also referred to as that the terminal device obtains the target parameter.

In operation 320, the terminal device determines the height information corresponding to the height of the terminal device based on the height threshold. Further, the terminal device obtains, based on the correspondence that is between the first parameter and the height information and that is received in operation 330, the target parameter corresponding to the height information of the terminal device, so that user experience at different heights is improved.

For example, optionally, the first parameter is a cell reselection/selection parameter. Optionally, there is correspondences between parameters in the cell reselection/selection parameter and the height information, or there is correspondences between some parameters in the cell reselection/selection parameter and the height information.

After determining, from the first parameter in the configuration information, the cell reselection/selection parameter corresponding to the height information of the terminal device, the terminal device performs cell reselection/selection based on the cell reselection/selection parameter.

According to the method 300 in this embodiment, for different heights, the first network device configures different cell selection/reselection parameters for the terminal device, so that different cell topologies are fully considered, thereby improving cell reselection reliability.

In a wireless communication network, for a terminal device in an idle mode, a network device provides a tracking area information (TAI) list or a TAC for the terminal device. The TAI includes a PLMN ID and the TAC. In at least one embodiment, the first network device configures a plurality of sets of tracking area parameters corresponding to different height information. In other words, the first network device configures, for the terminal device, a plurality of sets of tracking area identities corresponding to the height information. Optionally, in at least one embodiment, the first parameter is the tracking area parameter. After determining, in the first parameter, a tracking area parameter corresponding to the height information of the terminal device, in response to location information of the terminal device changing, the terminal device determines, based on the tracking area parameter, whether to trigger a tracking area update.

According to the method 300 in this embodiment, for different heights, the first network device configures a plurality of sets of different tracking area parameters for the terminal device, to avoid a ping-pong problem caused by unmatching tracking area parameters in response to the terminal device moving, that is, the terminal device repeatedly moves in two tracking areas.

For a terminal device in an inactive (inactive) mode, the network device provides a radio access network notification area (RNA) identifier list or the RNAC for the terminal device. The RNA identifier list includes the PLMN ID, the TAC, and a RAN area code. After the terminal device receives the RNA identifier list or the RNAC, during subsequent movement, in response to an RNA of a reselected cell not belonging to the RNA list, a radio access network-based notification area update (radio access network-based notification area update, RNAU) is triggered. Optionally, in at least one embodiment, the first parameter is the radio access network notification area parameter, and the radio access network notification area parameter includes a radio access network notification area identifier. After the terminal device determines, in the first parameter, a radio access network notification area parameter corresponding to the height information of the terminal device, in response to location information of the terminal device changing, the terminal device determines, based on the radio access network notification area parameter, whether to trigger the radio access network notification area update.

According to the method 300 in this embodiment, for different heights, the first network device configures, for the terminal device, a plurality of sets of radio access network notification area parameters corresponding to different height information, so that the terminal device is prevented from frequently triggering the radio access network notification area update at the different heights.

Optionally, in at least one embodiment, the first parameter is the measurement configuration parameter. According to the method 300 in this embodiment, for different heights, the first network device configures, for the terminal device, a plurality of sets of measurement configuration parameters corresponding to different height information. In other words, the terminal device performs measurement based on the height information of the terminal device. In other words, the terminal device measures different cells at the different heights.

Optionally, in at least one embodiment, the measurement configuration parameter includes one or more of an MDT measurement configuration parameter and a quality of service (quality of service, QoS) measurement configuration parameter, or the measurement configuration parameter alternatively includes a configuration parameter used for measuring power.

For example, in response to the first parameter being the measurement configuration parameter, at least one embodiment is shown in Table 6. The terminal device receives the configuration information from the first network device. The configuration information includes the measurement configuration parameter, the height threshold, and a correspondence between a height threshold and a measurement configuration parameter.

TABLE 6

| Measurement configuration parameter | Corresponding Height |
|---|---|
| Measurement configuration parameter 1 | Less than T_{hight1} |
| Measurement configuration parameter 2 | Greater than T_{hight1}, less than or |
| | equal to T_{hight2} |
| Measurement configuration parameter 3 | Greater than T_{hight2} |

As shown in Table 6, optionally, the measurement configuration parameter 1, the measurement configuration parameter 2, and the measurement configuration parameter 3 is included in the configuration information received from the first network device. The measurement configuration parameter 1 is a measurement whitelist and/or a measurement blacklist, for example, a white cell list 1 (white cell list 1) and/or a black cell list 1 (black cell list 1). The white cell list 1 and/or the black cell list 1 includes an identifier of a cell, and identifier information of the cell includes one or more of a physical cell identifier (physical cell identifier, PCI), a frequency, or cell global identification (cell global identification, CGI). In other words, in response to the terminal device determining, based on the height information, to perform measurement based on the measurement configuration parameter 1, the terminal device measures a cell in the white cell list 1. In response to the target parameter corresponding to the height information of the terminal device being the measurement configuration parameter 1, the terminal device measures the cell in the white cell list 1 and does not measure a cell in the black cell list 1, to improve measurement efficiency of the terminal device. The measurement configuration parameter 2 or 3 is similar to that of the measurement configuration parameter 1. Details are not described again herein.

It is easy to understand that Table 6 is an example implementation of Table 3 described in the method 300. To be specific, Table 6 is an example of the correspondence between the first parameter and the height information in the method 300. Alternatively, an implementation in which the correspondence between the first parameter and the height information is a function is used. This is not limited in at least one embodiment.

According to the method provided in at least one embodiment, the first network device sends at least one set of first parameters to the terminal device, where there is a correspondence between the first parameter and the height information; and the terminal device determines the height information based on the height of the terminal device, and further obtains the target parameter corresponding to the height information. In other words, the terminal device obtains, from the at least one set of first parameters that is related to the height information and that is received from the first network device, the first parameter corresponding to the height of the terminal device, and uses the first parameter as the target parameter, so that user experience at different heights is improved.

Optionally, the method 300 further includes an optional operation 310: The terminal device sends measurement information to the first network device, where the measurement information includes at least an identifier of a cell and a height corresponding to the cell, and the measurement information further includes measurement result information corresponding to the cell. The terminal device measures one or more cells, and the cell includes a serving cell and/or a neighboring cell. One or more cells in the measurement information is a cell that satisfies a preset criterion.

Optionally, the measurement information is information obtained based on event measurement, or is information obtained through periodic measurement.

Optionally, the terminal device obtains the measurement information at an interval of a specific height. Optionally, the terminal device autonomously decides to perform measurement, or the terminal device performs measurement based on an indication of the network device.

In a possible manner, the first network device updates the neighboring cell information based on the measurement information in operation 310, that is, the first network device maintains a neighbor relation based on the height information. Therefore, the first network device has neighbor relation information that is more accurate. Optionally, the first network device determines, based on the maintained neighbor relation, the configuration information sent in operation 330. For example, the first network device updates, based on the measurement information that includes the height information in operation 310, the correspondence between the height information and the first parameter in the configuration information sent in operation 330, so that the terminal device selects a corresponding target parameter based on the correspondence.

For example, the measurement information that includes the height information and that is received by the first network device includes an identifier of a cell and a corresponding height. For example, cell 1 corresponds to a height level 1, and cell 2 corresponds to a height level 2. That the first network device updates, based on the configuration information, the neighbor relation is: adding cell 1 to a cell corresponding to the height level 1, and adding cell 2 to a cell corresponding to the height level 2.

Optionally, the terminal device reports the height information to the first network device in response to reporting the cell global identification to the first network device. Alternatively, the terminal device reports the height information to the first network device in response to reporting MDT information. A method for sending, by the terminal device, the measurement information including the height information is similar to a method for sending, by a second network device, the first information including the height information in the method 400. Therefore, reference is further made to the following descriptions in the method 400. The first network device updates the neighboring cell information by using the measurement information that carries the height information and that is sent by the terminal device, so that the first network device provides, for the terminal device at different heights, a configuration corresponding to the height information, and the first network device updates the neighboring cell information.

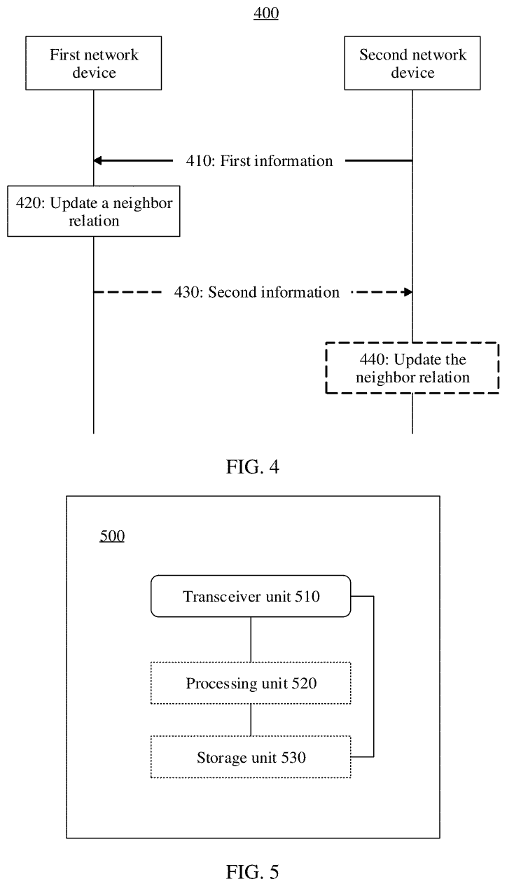

FIG. 4 is a schematic interaction diagram of a communication method 400 according to at least one embodiment. FIG. 4 shows the communication method by using an example in which a first network device and a second network device are execution bodies of an interaction example. However, the execution bodies of the interaction example are not limited.

Steps or procedures implemented by the first network device in FIG. 4 are also implemented by a chip, a chip system, a processor, or the like that supports the first network device in implementing the method. Steps or procedures implemented by the second network device in FIG. 4 are also implemented by a chip, a chip system, a processor, or the like that supports the second network device in implementing the method.

As shown in FIG. 4, the method 400 in this embodiment includes the following operations.

Operation 410: The first network device receives first information from the second network device, where the first information includes neighboring cell information of the second network device and height information corresponding to the neighboring cell information.

In this case, the first information includes a correspondence between neighboring cell information and height information.

The neighboring cell information is neighboring cell identifier information or neighboring cell list information. The neighboring cell information alternatively includes one or more of a tracking area parameter or a radio access network notification area parameter. The neighboring cell identifier information includes a PCI, and further includes CGI and/or frequency information.

In addition, the first information alternatively includes serving cell information. The serving cell is a cell that belongs to the second network device, or is referred to as a cell covered by the second network device. The serving cell is also referred to as the cell of the second network device. A cell of another network device adjacent to the serving cell is referred to as a neighboring cell.

In other words, the second network device maintains the neighboring cell information based on the height information. For descriptions of the height information, refer to related descriptions in the embodiment in FIG. 3. Details are not described herein again.

The second network device sends the first information to the first network device in response to establishing an interface with the first network device. Alternatively, the second network device sends the first information to the first network device after updating the neighbor relation.

In a possible manner, a cell has corresponding height information. To be specific, in response to the neighboring cell information being exchanged between network devices, height information is added for a cell.

Optionally, the height information carried in the neighboring cell information is a height range. For example, a height 1 shown in Table 7 is less than or equal to H1, a height 2 is greater than H1 and less than or equal to H2, and a height 3 is greater than H2, where H1 and H2 are specific heights, and H2>H1. Optionally, values of H1 and H2 is determined by the network device.

TABLE 7
Neighboring cell information

| Neighboring cell identifier | Height information |
|---|---|
| Neighboring cell 1 | Height 1 |
| Neighboring cell 2 | Height 2 |
| Neighboring cell 3 | Height 3 |

Optionally, the height information is alternatively a height threshold. Optionally, the height threshold is fixed, that is, network devices are set according to a unified threshold. Optionally, the height threshold is alternatively set by the network device.

In at least one embodiment, in response to network devices exchanging the neighboring cell information, height information is used as a classification basis, and the neighboring cell list information corresponding to a piece of height information is provided.

For example, as shown in Table 8, neighboring cell list 1 corresponds to a neighboring cell list used by a ground user and a low-height user, and neighboring cell lists 2 and 3 correspond to neighboring cell lists used by a high-height user. A neighboring cell list corresponds to one of height information. A design of the height information is similar to that of in the embodiment shown in FIG. 3. Details are not described herein again.

TABLE 8
Neighboring cell information

| | |
|---|---|
| Height 1 | Neighboring cell list 1 |
| Height 2 | Neighboring cell list 2 |
| Height 3 | Neighboring cell list 3 |
| Height 4 | Neighboring cell list 4 |

The neighboring cell list information is configured by a network management system for the network device. The network management system configures the neighboring cell list information for the second network device through network planning, or the second network device updates the neighboring cell list information based on neighboring cell information configured by the network management system and the second message received from the first network device, or the second network device updates the neighboring cell list information based on measurement information that is sent by a terminal device and that carries a cell identifier and a height corresponding to the cell identifier.

After receiving the first information from the second network device, the first network device stores the first information, and performs a corresponding operation or corresponding processing by using the first information. For example, the first network device updates, based on the first information, a neighbor relation maintained in the first network device. In other words, the method in at least one embodiment further includes operation 420: The first network device updates the neighbor relation. In this case, neighbor relations updated or maintained by the first network device also includes height information corresponding to the neighboring cell information.

The first network device also sends the neighbor relation to the second network device by using a similar method. In other words, the method further includes an optional operation 430: The first network device sends second information to the second network device, where the second information includes neighboring cell information of the first network device and the height information corresponding to the neighboring cell information, and an implementation method for carrying the height information by the second information is similar to that in the foregoing operation 410. In at least one embodiment, after receiving the second information from the first network device, the second network device stores the second information, and performs a corresponding operation or corresponding processing based on the second information. For example, the method further includes an optional operation 440: The second network device updates a neighbor relation of the second network device based on the second information. In this case, neighbor relations updated or maintained by the second network device also includes height information corresponding to the neighboring cell information.

In at least one embodiment, the first network device and the second network device exchange the neighboring cell information and height information corresponding to the neighboring cell information. Optionally, network devices alternatively exchange the tracking area parameter, height information corresponding to the tracking area parameter, and/or a radio access network notification area parameter, height information corresponding to the radio access network notification area parameter, and/or measurement configuration information and height information corresponding to the measurement configuration information in a similar manner. In other words, information exchanged in the embodiment shown in FIG. 4 is alternatively replaced with the tracking area parameter, and/or the radio access network notification area parameter, and/or a measurement configuration parameter and height information corresponding to these parameters. Details are not described herein again.

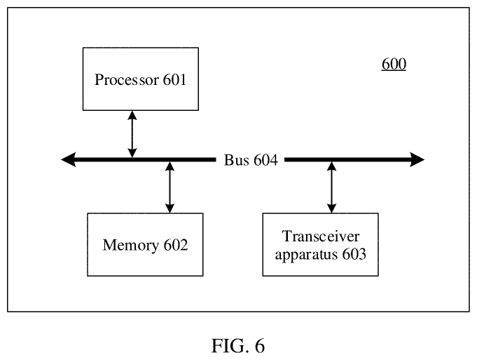

Apparatuses provided in at least one embodiment are described below in detail with reference to FIG. 5 and FIG. 6. Descriptions of apparatus embodiments correspond to the descriptions of the method embodiments. Therefore, for content that is not described in detail, refer to the method embodiments. For brevity, some content is not described herein again.

FIG. 5 shows a communication apparatus 500 according to at least one embodiment. The following describes a structure and function of the communication apparatus 500 with reference to FIG. 5. The communication apparatus 500 implements any function corresponding to the communication device in the embodiment shown in either of FIG. 3 and FIG. 4. The communication apparatus 500 is the terminal device mentioned in the foregoing embodiments, or is a first network device or a second network device. The communication apparatus 500 includes a transceiver unit 510. Optionally, the communication apparatus further includes at least one processing unit 520. Optionally, the communication apparatus further includes a storage unit 530. The storage unit stores data and/or instructions (or is referred to as code or a program). Both the transceiver unit 510 and the processing unit 520 performs exchange with the storage unit 530. For example, the processing unit 520 invokes data or instructions in the storage unit 530, so that the communication apparatus implement a corresponding method.

The processing unit in at least one embodiment is alternatively a processing module, a processing circuit, or a processor, and the transceiver unit is alternatively a transceiver module, a transceiver, a communication interface, an input/output circuit, or the like.

In a possible design, the communication apparatus 500 corresponds to corresponding operations of the terminal device in implementing the foregoing method embodiments. For example, the communication apparatus 500 is a terminal device, or is a component (for example, a processor, a chip, or a chip system) configured in the terminal device.

For example, the communication apparatus 500 correspondingly implements a corresponding operation of the terminal device in the foregoing method 300, and units or modules in the communication apparatus 500 is configured to perform the method performed by the terminal device in the method 300. In addition, the units in the communication apparatus 500 and the foregoing other operations and/or functions are separately used to implement corresponding procedures in the method 300.

For example, in response to the communication apparatus implementing a corresponding operation of the terminal device in the method 300, the processing unit 520 is configured to determine height information, where the height information is related to a first parameter.

Optionally, the transceiver unit 510 is configured to receive configuration information from the first network device, where the configuration information includes a correspondence between height information and a first parameter.

Optionally, the processing unit 520 is configured to determine a target parameter based on a current height of the terminal device, where the target parameter includes:

one or more of a tracking area parameter, a radio access network notification area parameter, or a measurement configuration parameter.

Optionally, the transceiver unit 510 is configured to send, to the first network device, measurement information that includes identification information of a cell and a height corresponding to the cell.

Optionally, the transceiver unit 510 is further configured to receive a height threshold from the configuration information, and the processing unit 520 is further configured to:

determine the height information based on the current height of the terminal device and the height threshold.

In another possible design, the communication apparatus 500 implements a corresponding operation of the first network device in the method 300, and the communication apparatus 500 includes a unit configured to perform the method performed by the first network device in the method 300. In addition, the units in the communication apparatus 500 and the foregoing other operations and/or functions are separately used to implement corresponding procedures in the method 300.

When the communication apparatus 500 corresponds to the first network device in the method 300, the processing unit 520 is configured to determine a correspondence between a first parameter and height information, and the transceiver unit 510 is configured to send configuration information to the terminal device. The configuration information includes the first parameter, where the first parameter is related to the height information.

Optionally, the transceiver unit 510 is configured to send the height threshold to the terminal device, where the height threshold is related to the height information. The processing unit 520 is further configured to determine the height information based on the current height of the terminal device and the height threshold.

Optionally, the transceiver unit 510 is configured to receive measurement information from the terminal device, where the measurement information includes identification information of a cell and a height corresponding to the cell. The processing unit 520 is further configured to update a neighbor relation based on the measurement information.

Optionally, the transceiver unit 510 is configured to receive first information from a second terminal device, where the first information includes neighboring cell information of the second network device and height information corresponding to the neighboring cell information. Optionally, the neighboring cell information of the second network device further includes one or more of a tracking area parameter or a radio access network notification area parameter. The processing unit 520 is further configured to update the neighbor relation based on the first information.

Optionally, the transceiver unit 510 is configured to send second information to the second network device, where the second information includes neighboring cell information of the first network device and height information corresponding to the neighboring cell information. Optionally, the neighboring cell information of the first network device further includes one or more of a tracking area parameter or a radio access network notification area parameter.

In another possible design, the communication apparatus 500 implements a corresponding operation of the second network device in the method 400, and the communication apparatus 500 includes a unit configured to perform the method performed by the second network device in the method 400. In addition, the units in the communication apparatus 500 and the foregoing other operations and/or functions are separately used to implement corresponding procedures in the method 400.

When the communication apparatus 500 corresponds to the second network device in the method 400, the transceiver unit 510 is configured to send the neighboring cell information of the second network device and the height information corresponding to the neighboring cell information to the first network device.

Optionally, the transceiver unit 510 is configured to receive the neighboring cell information of the first network device and the height information corresponding to the neighboring cell information from the first network device.

In a possible design, corresponding to the foregoing possible implementations, the processing unit 520 is a processor. Alternatively, the transceiver unit 510 is a transceiver apparatus, for example, the transceiver apparatus 603 shown in FIG. 6. Alternatively, the transceiver unit 510 is a communication interface. A storage unit 530 is a memory, for example, a memory 602 shown in FIG. 6.

Based on a same technical concept, at least one embodiment further provides a communication apparatus, configured to implement a function performed by the terminal device, the first network device, or the second network device in the foregoing method embodiments. FIG. 6 is a schematic block diagram of a possible communication apparatus 600 according to at least one embodiment. The communication apparatus includes at least one processor 601 and a memory 602. Optionally, the communication apparatus further includes a transceiver apparatus 603 and a system bus 604. The bus 604 is a PCI bus, an EISA bus, or the like. The bus is classified into an address bus, a data bus, a control bus, or the like. For ease of indication, the bus is indicated by using one bold line in FIG. 6. However, the use of one bold line does not indicate that there is one bus or one type of bus. The transceiver apparatus 603 is used by the communication apparatus 600 to perform communication interaction with another communication device (for example, a radio access network device or a terminal device, which is not limited herein), for example, interaction control signaling and/or service data. The transceiver apparatus 603 is implemented by using a circuit having a communication transceiver function. The memory 602 is configured to store program instructions and/or data. When the at least one processor invokes and executes the program instructions stored in the memory, the communication apparatus is enabled to implement a function of the terminal device in any design of the method 300. Alternatively, in response to the at least one processor invoking and executing the program instructions stored in the memory, the communication apparatus is enabled to implement a function of the network device (a first network device or a second network device) in any design of the method 300. The at least one processor 601, the memory 602, and the transceiver apparatus 603 are coupled through the system bus 604.

The processor and the transceiver apparatus described in at least one embodiment is implemented on an integrated circuit (integrated circuit, IC), an analog IC, a radio frequency integrated circuit RFIC, a hybrid signal IC, an application-specific integrated circuit (application-specific integrated circuit, ASIC), a printed circuit board (printed circuit board, PCB), an electronic device, or the like. The processor and the transceiver is alternatively manufactured by using various 1C process technologies, for example, a complementary metal oxide semiconductor (complementary metal oxide semiconductor, CMOS), an n-type metal oxide semiconductor (nMetal-oxide-semiconductor, NMOS), a p-type metal oxide semiconductor (positive channel metal oxide semiconductor, PMOS), a bipolar junction transistor (Bipolar Junction Transistor, BJT), a bipolar CMOS (BiCMOS), silicon germanium (SiGe), and gallium arsenide (GaAs). Optionally, the processor includes one or more processors, for example, include one or more CPUs. When the processor is one CPU, the CPU is a single-core CPU or a multi-core CPU. The transceiver apparatus is configured to: send and receive data and/or a signal, and receive data and/or a signal. The transceiver apparatus includes a transmitter and a receiver. The transmitter is configured to send data and/or a signal, and the receiver is configured to receive data and/or a signal. The transceiver is also a communication interface. The memory includes but is not limited to a random access memory (random access memory, RAM), a read-only memory (read-only memory, ROM), an erasable programmable read-only memory (erasable programmable read-only memory, EPROM), and a compact disc read-only memory (compact disc read-only memory, CD-ROM). The memory is configured to store a related instruction and/or data.

At least one embodiment provides a computer-readable storage medium. The computer-readable storage medium stores computer instructions used to implement the method performed by the terminal device or the method performed by the network device in the foregoing method embodiments.

For example, in response to the computer program being executed by a computer, the computer is enabled to implement the method performed by the terminal device or the method performed by the network device in the foregoing method embodiments.

At least one embodiment provides a computer program product including instructions. When the instructions are executed by a computer, the computer is enabled to implement the method performed by the terminal device or the method performed by the network device in the foregoing method embodiments.

At least one embodiment provides a communication system. The communication system includes the network device and the terminal device in the foregoing embodiments.

For explanations and beneficial effects of related content of any communication apparatus provided above, refer to a corresponding method embodiment provided above. Details are not described herein again.

At least one embodiment is implemented by using software, hardware, firmware, or any combination thereof. When the software is used, at least one embodiment is implemented in a form of a computer program product. The computer program product includes one or more computer instructions. When the computer program instructions are loaded and executed on a computer, the procedures or functions according to at least one embodiment are generated. The computer is a general-purpose computer, a dedicated computer, a computer network, or other programmable apparatuses. For example, the computer is a personal computer, a server, a network device, or the like. The computer instructions is stored in the computer-readable storage medium or is transmitted from a computer-readable storage medium to another computer-readable storage medium. For example, the computer instructions is transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium is any usable medium accessible by the computer, or a data storage device, such as a server or a data center, integrating one or more usable media. The usable medium is a magnetic medium (for example, a floppy disk, a hard disk, or a magnetic tape), an optical medium (for example, a DVD), a semiconductor medium (for example, a solid-state drive (solid state disk, SSD)), or the like. For example, the usable medium includes but is not limited to any medium that stores program code, such as a USB flash drive, a removable hard disk, a read-only memory (read-only memory, ROM), a random access memory (random access memory, RAM), a magnetic disk, or an optical disc.

A person skilled in the art understands that first, second, and various reference numerals are for distinguishing for ease of description, and are not used to limit the scope of embodiments embodiments described herein. A specific value of a numeral (which is also referred to as an index), a specific value of a quantity, and a location are used as an example, but are not unique representation forms, and are not used to limit the scope of embodiments described herein. First, second, and various reference numerals are also for distinguishing for ease of description, and are not used to limit the scope of embodiments described herein.

In at least one embodiment, unless otherwise specified, an element represented in a singular form is intended to represent “one or more”, but is not intended to represent “one and only one”. In at least one embodiment, unless otherwise specified, “at least one” is intended to represent “one or more”, and “a plurality of” is intended to represent “two or more”.

In addition, the terms “system” and “network” are usually used interchangeably in this specification. The term “and/or” describes an association relationship for describing associated objects and represents that three relationships exist. For example, A and/or B represent the following three cases: only A exists, both A and B exist, and only B exists. A is singular or plural, and B is singular or plural. The character “/” generally indicates an “or” relationship between associated objects.

The term “at least one of” indicates a combination of listed items. For example, “at least one of A, B, and C” indicates the following six cases: A exists alone, B exists alone, C exists alone, A and B coexist, B and C coexist, and A, B, and C coexist. A is singular or plural, B is singular or plural, and C is singular or plural.

In at least one embodiment, “B corresponding to A” indicates that B is associated with A, and B is determined based on A. However, determining B based on A does not mean that B is determined based only on A. B is alternatively determined based on A and/or other information.

For same or similar parts in at least one embodiment, refer to each other. In at least one embodiment, unless otherwise specified or a logical conflict occurs, terms and/or descriptions are consistent and are mutually referenced between different embodiments and between the implementations/implementation methods/implementation methods in embodiments. Technical features, in at least one embodiment, are combined to form a new embodiment according to an internal logical relationship thereof. The foregoing descriptions are not intended to limit the protection scope of embodiments described herein.

The foregoing descriptions are provided as examples of at least one embodiment, but are not intended to limit the protection scope. Any variation or replacement readily figured out by a person skilled in the art within the technical scope disclosed herein falls within the protection scope of at least one embodiment.

1. A communication method, comprising:
receiving configuration information from a first network device, wherein the configuration information includes a correspondence between height information and a first parameter; and
determining a target parameter based on a current height of a terminal device and the configuration information, wherein
the first parameter includes one or more of a tracking area parameter, a radio access network notification area parameter, a cell selection or reselection parameter, or
a measurement configuration parameter.

2. The method according to claim 1, wherein the receiving the configuration information further includes receiving a height threshold, and
the determining the target parameter based on the current height of the terminal device and the configuration information includes: determining current height information based on the current height and the threshold, and determining the target parameter based on the current height information and the configuration information.

3. The method according to claim 1, wherein the height information includes a height range, or a height level.

4. The method according to claim 1, wherein the method further comprises:
sending measurement information to the first network device, wherein the measurement information includes identification information of a cell and a height corresponding to the cell.

5. A communication method, comprising:
determining, by a first network device, a correspondence between a first parameter and height information; and
sending, by the first network device, configuration information to a terminal device, wherein the configuration information includes the correspondence between the height information and the first parameter, and
the first parameter includes one or more of a tracking area parameter, a radio access network notification area parameter, a cell selection or reselection parameter, and a measurement configuration parameter.

6. The method according to claim 5, wherein the height information includes a height range, or a height level.

7. The method according to claim 5, wherein the sending the configuration information includes sending a height threshold, wherein the height threshold is related to the height information.

8. The method according to claim 5, wherein the method further comprises:
receiving measurement information from the terminal device, wherein the measurement information includes identification information of a cell and a height corresponding to the cell.

9. A communication apparatus, comprising:
a memory storing computer-readable instructions;
a transceiver receiving configuration information from a first network device, wherein the configuration information includes a correspondence between height information and a first parameter; and
a processor connected to the memory, wherein the processor is configured to execute the computer-readable instructions to:
determine a target parameter based on a current height of the communication apparatus and the configuration information, wherein
the first parameter includes one or more of a tracking area parameter, a radio access network notification area parameter, a cell selection or reselection parameter, and or
a measurement configuration parameter.

10. The apparatus according to claim 9, wherein the configuration information further includes a height threshold, and
the processor determines the target parameter based on the current height of the communication apparatus and the configuration information by: determining current height information based on the current height and the threshold, and determining the target parameter based on the current height information and the configuration information.

11. The apparatus according to claim 9, wherein the height information includes a height range, or a height level.

12. The apparatus according to claim 9, wherein the transceiver is further configured to:
send measurement information to the first network device, wherein the measurement information includes identification information of a cell and a height corresponding to the cell.
